(19) United States
(12) Patent Application Publication
(10) Pub. No.: US 2011/0253884 A1
(43) Pub. Date: Oct. 20, 2011

(54) LIGHT BARRIER AND METHOD FOR THE OPERATION OF A LIGHT BARRIER

(76) Inventors: Bernd Ottleben, Bad Salzdetfurth (DE); Petra Ottleben, Bad Salzdetfurth (DE)

(21) Appl. No.: 13/141,124

(22) PCT Filed: Dec. 16, 2009
(86) PCT No.: PCT/DE2009/001773

§ 371 Date: Jun. 21, 2011

(30) Foreign Application Priority Data
Dec. 24, 2008 (DE) 10 2008 063 079.9

(51) Int. Cl. H01J 40/14

(52) U.S. Cl. 250/221

(57) ABSTRACT

A light barrier having a signal path (1) between a first transceiver arrangement (2), emitting a signal beam (4), and a mirror, returning the incident signal beam (4), allows reliable operation even when the length is great and under changing ambient conditions by virtue of the mirror being in the form of a second transceiver arrangement (3) and by virtue of both transceiver arrangements (2, 3) having a receiver (6), a controllable and encodable transmitter (8) and an evaluation and control device (7), connected to the receiver (6), for evaluating the intensity and an encoding of the received signal beam (4, 5), and for controlling the intensity and encoding of the emitted signal beam (4, 5), wherein the encoding is performed using a piece of information about the intensity of the received signal beam (4, 5).

The invention relates to a light barrier having a signal path between a first transceiver arrangement, which emits a signal beam, and a reflecting device which returns the incident signal beam.

The invention also relates to a method for operating a light barrier in which signal beams are emitted between two ends of a signal path.

Light barriers are known to be used to detect the existence or entry of an object into a linear signal path. In the simplest case, a light barrier consists of a transmitter, which emits an electromagnetic signal, and a receiver which receives the signal. Such a light barrier requires transmitting electronics at one end of the signal path and receiver electronics at the other end of the signal path. The two devices must be connected to one another for evaluation purposes.

In many cases, in particular in the case of very long light barriers, it is not expedient to establish an electronic connection between the two ends of the signal path. In special applications, for example in a large production hall or in a car wash, complicated cable laying is needed to connect the two sets of electronics since a direct connection between the transmitter and receiver electronics is not possible.

It is also known practice to design a light barrier in such a manner that a transceiver arrangement is provided at one end of the signal path, while only a mirror is required at the other end, which mirror reflects the emitted light beam, preferably on the same optical axis, with the result that the transceiver arrangement itself receives the emitted signal beam again and can evaluate the latter. In this manner, transmitting and receiving electronics are required only at one end of the signal path. However, the disadvantage of this arrangement is that the effective signal path is more than doubled as a result of the use of a mirror, with the result that signal attenuation which can no longer be tolerated can occur in the case of long signal paths. It is also disadvantageous that a reflective object is not detected under certain circumstances since it performs the function of the mirror of the light barrier and the interruption in the signal path caused by the object therefore cannot be detected at the receiving electronics.

The present invention is based on the object of designing and operating a light barrier in such a manner that, on the one hand, simple installability without complicated cable laying between the ends of the signal path can be achieved, and, on the other hand, adapted emission of the signal beam, on the one hand, and good detectability, on the other hand, are possible even under unfavorable environmental conditions.

In order to achieve this object, a light barrier of the type mentioned at the outset is characterized, according to the invention, in that the reflecting device is in the form of a second transceiver arrangement, and in that the two transceiver arrangements have a receiver, a controllable and codable transmitter and an evaluation and control device which is connected to the receiver and is intended to evaluate the intensity and coding of the received signal beam and to control the intensity and coding using an item of information relating to the intensity of the received signal beam.

In order to achieve the object, a method of the type mentioned at the outset is also characterized, according to the invention, in that a transceiver arrangement is arranged at both ends of the signal path, in that the two transceiver arrangements emit a signal beam and receive the signal beam emitted by the other transceiver arrangement, in that the two transceiver arrangements determine the signal intensity of the received signal beam and provide their own emitted signal beam with coding using the received signal intensity, and in that the two transceiver arrangements set the intensity of the signal beam emitted by them on the basis of the coding in the received signal beam, a suitable control algorithm being able to be used for control.

The invention is based on the fact that a transceiver arrangement is provided at both ends of the signal path, each of which arrangements is provided with an evaluation and control device. An evaluation part of the evaluation and control device is able, on the one hand, to determine the intensity of the received signal beam and, on the other hand, to decode coding contained in the received signal beam using the intensity of the signal beam received at the other end of the signal path, as measured by the other signal receiver arrangement. The control part of the evaluation and control device is then used to set the signal strength of the emitted beam according to the decoding which has been carried out and also to code the emitted signal beam in order to transmit the information relating to the intensity of the received signal beam. Since this information transmission and evaluation is carried out at both ends of the signal path, the signal beams transmitted on the signal path are completely controlled, with the result that the light barrier according to the invention is automatically adapted to unfavorable environmental conditions, for example a changing dust content in the air of the signal path. In order to detect an interruption in the signal beam, the intensity of the received signal can be compared with a threshold value. In one embodiment of the invention, an output switching stage of the transmitter can be controlled using the detected and evaluated intensity in order to provide the emitted signal with corresponding coding for the received signal strength. This control of the transceiver arrangements makes it possible to detect and indicate a complete interruption in the signal beams.

The two transceiver arrangements may continuously emit the signal beams if they use signal beams at different frequencies. In this case, the coding may be effected by changing the frequency of the emitted signal around a predefined center frequency. It goes without saying that it is also possible for the two transceiver arrangements to emit signal beams with different carrier frequencies and for the coding to be modulated onto the carrier frequencies.

However, it is preferred if the two transceiver arrangements each alternately emit signal beams, with the result that the first transceiver arrangement emits a signal, while the second transceiver arrangement takes a break in transmission and vice versa. In this case, the frequency between transmission and pausing may be selected to be so high that virtually continuous signal beams are produced for the measuring purposes of a light barrier. In the case of this transmission method, the two transceiver arrangements must be synchronized with one another. The processors present in the evaluation and control devices of the transceiver arrangements must therefore be adjusted to one another in terms of their operating clock. This is preferably effected by virtue of the fact that a first transceiver arrangement is connected as a master and the other transceiver arrangement is connected as a slave, that is to say can be adjusted to the clock frequency of the master.

For the present invention, it is preferred for the two transceiver arrangements to have an identical construction and to be changed over as master or slave by means of an adjustment, preferably an adjustment switch.

The invention shall be explained in more detail below using exemplary embodiments which are illustrated in the drawing, in which:

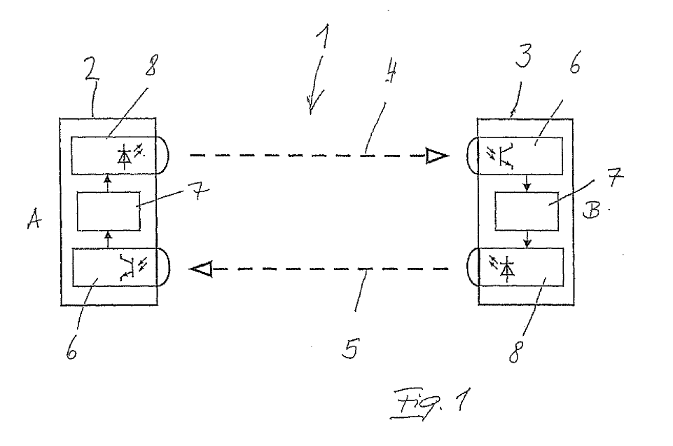

FIG. 1 shows a basic circuit diagram of an embodiment of a light barrier according to the invention;

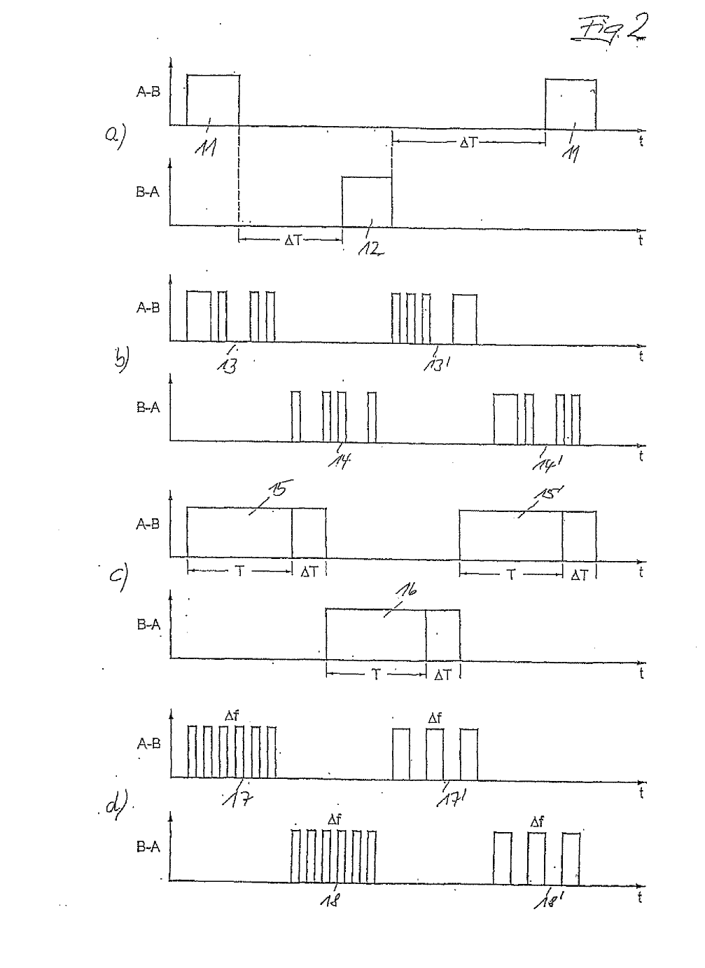

FIG. 2 shows an exemplary illustration of a plurality of possible signal formations for coding the emitted signal using the information relating to the received signal intensity.

FIG. 1 schematically shows a signal path 1, at the ends of which a first transceiver arrangement 2 and a second transceiver arrangement 3 are situated. The first transceiver arrangement 2 directs a first signal beam 4 toward the second transceiver arrangement 3. In the opposite direction, a second signal beam 5 runs from the second transceiver arrangement 3 to the first transceiver arrangement 2.

The two transceiver arrangements have the same construction and comprise a receiver 6 which can be used to detect the reception of the respective light beam 4, 5 and to measure the intensity (signal strength) of said beam. The drawing therefore depicts a symbol for a phototransistor in the receiver. The signal received by the receiver 6 is passed to an evaluation and control device 7 in which an evaluation part and a control part are situated. In the evaluation part, the intensity of the signal beam 4, 5 received by the receiver 6 is determined and is preprocessed for the control part, for example in the form of a controller for an output switching stage for the emitted light beam 4, 5, in order to introduce coding into the signal beam 4, 5. Coding contained in the received signal beam 4, 5 is also decoded in the evaluation part of the evaluation and control device 7 and is preprocessed for the control part of the evaluation and control device 7.

A transmitter 8 which can be used to emit a signal beam is connected to the evaluation and control device 7. In the drawing, the transmitter 8 is therefore indicated with the symbol of a transmitting diode.

In the control part of the evaluation and control device 7, the decoded coding from the received signal beam 4, 5 is converted into a control signal for the intensity of the signal beam 4, 5 emitted by the transmitter 8. The determined intensity of the signal beam 4, 5 received by the receiver is also converted into coding which is used to code the signal beam 4, 5 emitted by the transmitter 8, with the result that, after the signal beam 4, 5 has been transmitted, the other transceiver arrangement 2, 3 receives, via the coding, the information relating to the intensity with which the signal beam 4, 5 emitted by its transmitter 8 has been received by the other transceiver arrangement 2, 3.

Since the two transceiver arrangements 2, 3 are not connected to one another by means of signal lines but merely need to be connected to a suitable power supply, which may also be a power supply independent of the mains (batteries), the information relating to the transmission quality of the signal path 1 is transmitted to the respective other transceiver arrangement via the coding of the signal beams 4, 5, from which the receiving transceiver arrangement 2, 3 gathers the information relating to the signal strength with which its transmitter 8 must emit the signal beam 4, 5.

The two signal beams 4, 5 are completely controlled in this manner since the information relating to the remaining signal strength at the other end of the signal path 1 is transmitted to the respective other transceiver arrangement 2, 3 via the signal beams 4, 5.

In order to start the control operation, it is expedient for one of the two transceiver arrangements, as master, to start to transmit with a maximum signal strength or with a very low signal strength which is respectively gradually increased. In this manner, either a (regularly overdriven) signal which has been emitted with maximum signal intensity is immediately received in the transceiver arrangement 3 operating as the slave or a signal with a minimum reception strength is received therein only after a certain time. In both cases, the control operation at both ends of the signal path 1 begins with the reception of the signal emitted by the master.

FIG. 2 illustrates signals which can form the signal beams. In this case, the end of the first transceiver arrangement 2 is denoted A and the end of the signal path 1 having the second transceiver arrangement 3 is denoted B. Consequently, A-B respectively denotes the first signal beam 4 and B-A respectively denotes the second signal beam 5.

In the exemplary embodiment illustrated in FIG. 2a, the first transceiver arrangement 2 emits a pulse packet 11. Depending on the signal intensity which has been determined by the receiver 6 of the second transceiver arrangement 3, a response pulse packet 12 is returned by the transmitter 8 of the second transceiver arrangement 3 as a transmission beam 5 after a certain period of time ΔT. The period of time ΔT thus contains the coding using the signal field strength of the transmission signal 4 at the receiver 6 of the second transceiver arrangement 3. The pulse packet 12 emitted by the second transceiver arrangement is received by the receiver 6 of the first transceiver arrangement 2 and is evaluated with regard to the received signal intensity. The period of time AT between the signal packet 11 and the signal packet 12 provides the first transceiver arrangement 2 with the information relating to the transmission strength with which the next signal beam 4 is intended to be emitted. Depending on the intensity of the received signal, the first transceiver arrangement 2 sets the interval of time ΔT at which the next pulse packet 11 is emitted. The coding using the received signal strength is thus contained in the interval of time ΔT between the received pulse packet 12 and the pulse packet 11 which is then emitted. In this manner, the intensity of the transmission signals emitted by the two transceiver arrangements 2, 3 is continuously controlled.

In the exemplary embodiment illustrated in FIG. 2b, digitally coded signals 13, 13′ are emitted by the first transceiver arrangement 2 and digital transmission signals 14, 14′ are emitted by the second transceiver arrangement 3. In this case, the transmission signals are emitted in interleaved form, with the result that there is a transmission pause between the digital signals 13, 13′, in which pause a digital signal 14, 14′ from the other transceiver arrangement 3 can be emitted. The detection of the digital transmission signals 13, 13′; 14, 14′ presupposes that the processors in the evaluation and control devices 7 of the two transceiver arrangements 2, 3 are synchronized with one another.

In the exemplary embodiment illustrated in FIG. 2c, pulse packets 15, 15′ are emitted by the first transceiver arrangement 2 in a fixed time frame. In a manner interleaved therewith, the second transceiver arrangement likewise emits pulse packets 16 in a fixed time frame.

In this case, the coding using the intensity of the received signal lies in the length T of the pulse packet 15, 15′, 16 and the length of the associated interval of time ΔT which supplements the length T of the pulse packet 15 to form a constant predefined duration, with the result that T+ΔT=const. for all pulses 15, 15′, 16.

FIG. 2d shows another exemplary embodiment in which pulse packets 17, 17′ of the length T are emitted by the first transceiver arrangement 2 and pulse packets 18, 18′ are emitted by the second transceiver arrangement 3. The pulse packets have a constant pulse packet length. The information relating to the received signal intensity lies in the number of pulses per pulse packet or in the frequency with which the pulses occur in the pulse packet.

Whereas the pulse packet 17 has six pulses in the exemplary embodiment illustrated, the pulse packet 17′ contains only three pulses. The evaluation can be carried out by counting the pulses over the predefined pulse packet length or by determining the pulse frequency within the pulse packets.

In all cases, it is possible to evaluate the coding of the transmitted electromagnetic signals in the signal beams 4, 5 without any problems and using conventional processors.

The present invention is suitable for all types of light barriers, that is to say for light barriers which operate with visible light or else with infrared radiation or ultraviolet radiation.

1. A light barrier having a signal path (1) between a first transceiver arrangement (2), which emits a signal beam (4), and a reflecting device which returns the incident signal beam (4), wherein the reflecting device is in the form of a second transceiver arrangement (3), and in that the two transceiver arrangements (2, 3) have a receiver (6), a controllable and codable transmitter (8) and an evaluation and control device (7) which is connected to the receiver (6) and is intended to evaluate the intensity and coding of the received signal beam (4, 5) and to control the intensity and coding of the emitted signal beam (4, 5), the coding being effected using an item of information relating to the intensity of the received signal beam (4, 5).

2. The light barrier as claimed in claim 1, wherein the two transceiver arrangements (2, 3) are set up to emit different signals.

3. The light barrier as claimed in claim 2, wherein the two transceiver arrangements (2, 3) emit signals at different frequencies.

4. The light barrier as claimed in claim 3, wherein the signal beams are modulated with coding signals.

5. The light barrier as claimed in claim 4, wherein the frequencies of the emitted signal beams (4, 5) can be varied within a predefined coding frequency range.

6. The light barrier as claimed in claim 1, wherein, the transceiver arrangements (2, 3) can be synchronized with one another, and in that the first transceiver arrangement (2) is set up as a master and the second transceiver arrangement (3) is set up as a slave.

7. The light barrier as claimed in claim 6, wherein the two transceiver arrangements (2, 3) can be changed over as master or slave.

8. The light barrier as claimed in claim 6, wherein the signal beams (4, 5) emitted by the two transceiver arrangements (2, 3) have pulse signals which comprise the coding.

9. The light barrier as claimed in claim 8, wherein the coding involves setting the pulse length, pulse spacing, pulse packet length, pulse packet spacing and/or pulse frequency.

10. The light barrier as claimed in claim 8, wherein the signal beam (4) from the first transceiver arrangement (2) and the signal beam (5) from the second transceiver arrangement (3) are emitted in a temporally interleaved manner.

11. The light barrier as claimed in claim 8, wherein the emitted signal beam (4, 5) consists of concatenated signals.

12. A method for operating a light barrier in which signal beams (4, 5) are emitted between two ends (A, B) of its signal path (1), wherein a transceiver arrangement (2, 3) is arranged at both ends (A, B) of the signal path (1), in that the two transceiver arrangements (2, 3) emit a signal beam (4, 5) and receive the signal beam (4, 5) emitted by the other transceiver arrangement (2, 3), in that the two transceiver arrangements (4, 5) determine the signal intensity of the received signal beam (4, 5) and provide their own emitted signal beam (4, 5) with coding using the received signal intensity, and in that the two transceiver arrangements (2, 3) set the intensity of the signal beam (4, 5) emitted by them on the basis of the coding in the received signal beam (4, 5).

13. The method as claimed in claim 12, wherein the signal beams (4, 5) from the two transceiver arrangements (2, 3) are alternately emitted.

14. The method as claimed in claim 13, wherein the signal beams (4, 5) are emitted in the form of pulses or pulse packets, and in that the coding consists of the length of the pulses or pulse packets or a pause between the pulses or pulse packets.

15. The method as claimed in claim 13, wherein the coding is carried out by means of digital signal sequences.

16. The method as claimed in claim 12, wherein the signal beams (4, 5) are emitted in the form of AC voltage signals, and the coding is effected by changing the frequency of the AC voltage signals.

17. The method as claimed in claim 12, wherein the signal beams (4, 5) are emitted at different wavelengths.

18. The method as claimed in claim 17, wherein the signal beams (4, 5) are emitted at the same time.
